(19) United States
(12) Patent Application Publication
(10) Pub. No.: US 2025/0098692 A1
(43) Pub. Date: Mar. 27, 2025

(54) GERMINATION/SPROUTING AND FRUIT RIPENING REGULATORS

(71) Applicant: The United States of America, as Represented by the Secretary of Agriculture, Washington, DC (US)

(72) Inventors: TIANBAO YANG, ROCKVILLE, MD (US); JORGE M. FONSECA, HYATTSVILE, MD (US)

(21) Appl. No.: 18/975,154

(22) Filed: Dec. 10, 2024

Related U.S. Application Data
(63) Continuation of application No. 17/702,885, filed on Mar. 24, 2022, now abandoned.
(60) Provisional application No. 63/165,996, filed on Mar. 25, 2021.

(51) Int. Cl. A23B 7/10; A01N 33/10; A01N 37/40; A01N 41/06; A01N 43/16; A01N 43/40; A01N 43/60; A01N 43/76; A01N 47/32; A01N 47/38; A01P 21/00

(52) U.S. Cl. CPC A23B 7/10; A01N 33/10; A01N 37/40; A01N 41/06; A01N 43/16; A01N 43/40; A01N 43/60; A01N 43/76; A01N 47/32; A01N 47/38; A01P 21/00

(57) ABSTRACT

The invention relates to compositions comprising an agriculturally-acceptable carrier, adjuvant, auxiliary, or extender and at least one ABA antagonist for promoting germination/sprouting of plants or plant parts, and/or delaying fruit ripening and pigmentation; kits comprising such compositions; and methods of using such compositions to promote germination/sprouting of plants or plant parts, and/or to delay fruit ripening and pigmentation.

### CROSS-REFERENCE TO RELATED APPLICATIONS

This application is a continuation of U.S. patent application Ser. No. 17/702,885, filed Mar. 24, 2022, which claims the benefit of U.S. Provisional Patent Application No. 63/165,996, filed Mar. 25, 2021. The content of these applications is incorporated herein by reference in its entirety.

### FIELD OF THE INVENTION

The invention relates to compositions comprising at least one abscisic acid (ABA) antagonist that are useful for promoting plant or plant part germination/sprouting, and/or delaying fruit ripening and pigmentation. Also part of the invention are kits comprising such compositions, and methods for using such compositions.

### BACKGROUND OF THE INVENTION

Severe damage or destruction of fruit crops can be caused by adverse weather events such as storms, frost, and hail, or by the proliferation of microorganisms that spoil the fruit. Shortening the time fruit is on the plant, vine, or tree reduces the risk of weather related damage, but this may cause the fruit to be harvested at suboptimal times such that the fruit is not yet sufficiently ripe.

A major concern with ripened fruit is that it does not last very long before it begins to spoil. The loss of firmness and the production of sugars associated with ripening are some of the factors that render the fruit more susceptible to pathogens like bacteria and spoilage. Over-softening of fruit is a major cause of spoilage during transportation, particularly for tropical fruits, such as mangoes and bananas. Spoilage can be reduced by rapid transportation of fresh fruits, or by slowing down fruit ripening. One way to slow down fruit ripening is by lowering the temperature. Cold temperatures above freezing are usually used. Even though all fruits can be frozen, upon thawing many fruits lose their flavor and their texture and become very mushy. Several fruits, such as bananas, can be damaged by chilling, which limits this approach. Another way to slow down ripening is by controlling the atmosphere around the fruit, primarily by increasing carbon dioxide levels and reducing oxygen levels. Fruit need oxygen to ripen, so if there is less oxygen in the atmosphere, the fruit will ripen more slowly. One final way to slow down ripening is to block the action of ethylene, a gas produced by plants, and known as the “ripening hormone,” which stimulates fruit ripening. Ethylene is a hormone required to trigger fruit ripening, and it can be blocked by using synthetic compounds, such as 1-methyl-cyclo-propene (1-MCP). 1-MCP is also used to maintain the freshness of cut flowers. To delay softening and ripening of fruit, and wilting and fading of flowers, growers spray plants with products that contain 1-MCP, however 1-MCP is not very effective in delaying ripening of non-climacteric fruits, or in climacteric fruits that are treated at advanced stages of maturation.

Many climacteric fruits may be intentionally harvested before they are fully ripe, but after their physiological maturity, while conditions are favorable to harvest. Non-climacteric fruits are allowed to ripen on the plant, vine, or tree because once the fruit is harvested, the fruit's desirable properties, such as taste, color, and texture, typically do not improve. Examples of non-climacteric fruit include grapes, cherries, strawberries, pineapples, raspberries, and citrus. Because non-climacteric fruit are ideally ripe before they are harvested, non-climacteric fruit can be more difficult to store, and spoil more easily than climacteric fruit. This is where adverse weather conditions or proliferation of microorganisms at ideal weather conditions can play a pivotal role. Reducing the amount of time fruit spends on the plant, tree, or vine reduces the changes of adverse weather-related events spoiling a crop. If a storm or hail is predicted and the fruit is not quite ripe, the fruit may be picked early at a suboptimum time leading to an inferior fruit product.

Fruit picked early, when it is not sufficiently ripe, is likely to have lower levels of total soluble solids (TSS) and higher amounts of acid measured by its titratable activity (TA) (often referred to as the “total acidity”). As fruit ripens, the amount of sugar (soluble solids) typically increases and the acidity falls. Fruit with lower levels of TSS and higher TA are perceived as being sour or tart and are generally not preferred by consumers compared to fruit that has higher levels of TSS and lower TA. Fruit allowed to stay in the plant for longer time not only tend to change acidity and sugars, but also accumulate compounds that are determinants of the flavor of that fruit, some being volatiles. For example, bananas that are harvested after reaching the physiological maturity, even if still green at that point, later in storage can get the same sweetness of those that remain in the plant. The difference is that those in the plant have higher accumulation of those compounds that characterize the fresh banana flavor, although sweetness and acidity can be pretty much the same. Mangos and other tropical fruits are also good examples, in fact, that is the reason there is a market niche with mangos being transported via airplane (after allowing full maturity of the fruit in the tree). Thus, it is possible to get more flavorful fruits from the start/harvest, slowing down postharvest physiology development. In most instances, consumers prefer fruits that have been harvested ripe and has more organoleptically appealing properties, such as color, taste (sweetness), and texture.

Non-climacteric fruits like strawberries and oranges do not continue the ripening process after harvesting so they are usually picked upon full ripening for maximum flavor. Slowing food ripening of non-climacteric fruits can extend their shelf life, reduce food waste, and make imported fruits available in new and different marketplaces.

ABA is a phytohormone that functions in many plant developmental processes, including seed and bud dormancy, control of organ size, and stomatal closure. ABA has been shown to inhibit seed germination and promote fruit ripening. Thus, there is a need for compositions comprising ABA antagonists that are not phytotoxic, are easily synthesized, and which are useful in promoting germination/sprouting and/or delaying/inhibiting fruit ripening and pigmentation.

### SUMMARY OF THE INVENTION

Provided herein are compositions comprising at least one ABA antagonist, kits comprising such compositions, and methods of using such compositions to promote plant or plant part sprouting/germination, and/or to delay fruit ripening and pigmentation.

In an embodiment, the invention relates to a composition for promoting plant or plant part germination/sprouting and/or delaying fruit ripening and pigmentation, the composition comprising at least one abscisic acid (ABA) antagonist as disclosed herein. In some embodiments of the invention, the composition for promoting plant or plant part germination/sprouting, and/or delaying fruit ripening and pigmentation optionally comprises a carrier, an adjuvant, an auxiliary, or an extender. In some embodiments of the invention, the composition for promoting plant or plant part germination/sprouting, and/or delaying fruit ripening and pigmentation comprises a surfactant and at least one ABA antagonist. In some embodiments of the invention, the surfactant in the composition for promoting plant or plant part germination/sprouting, and/or delaying fruit ripening and pigmentation is polyethylene glycol tert-octylphenyl ether (TRITON-X100); polyoxyethylene (10) isooctylcyclohexyl ether (TRITON-X100 reduced); Polyoxyethylene (10) cetyl ether (BRIJ C10); polysorbate 20; octylphenoxypolyethoxyethanol; or nonylphenoxypolyethoxy ethanol.

In some embodiments of the invention, the at least one ABA antagonist in the composition for promoting plant or plant part germination/sprouting, and/or delaying fruit ripening and pigmentation is N-[3-chloro-4-(4-propionyl-1-piperazinyl)phenyl]-2-phenylacetamide (PAD); N-(3-chloro-4-[4-(2,2-dimethylpropanoyl)-1-piperazinyl]phenyl)-2-phenylacetamide; 1-[(4-methoxyphenyl) sulfonyl]-3-piperidinecarboxamide; N-(3,4-dimethylphenyl)-N-(4-fluorobenzyl) methanesulfonamide; [3-(benzyloxy)benzyl]methylamine hydrochloride; 4-amino-2-(5,7-dimethyl-1,3-benzoxazol-2-yl)-6-methylphenol; N-cyclopropyl-N′-(2,3-dimethylphenyl) urea; N-[3-(1,3-benzoxazol-2-yl)-2-methylphenyl]-2-methylpropanamide; 3-[(2-fluorobenzyl)oxy]benzamide; N-[3-chloro-4-(4-propionyl-1-piperazinyl)phenyl]-2-methoxy-3-methylbenzamide; 6-chloro-N-(2,4-dimethylphenyl)-2-oxo-2H-chromene-3-carboxamide; methyl 2-{[(4-cyclohexyl-1-piperazinyl)carbonyl]amino}benzoate; or a derivative thereof.

In some embodiments, exposure to the composition of the invention promotes germination/sprouting of climacteric or non-climacteric plants or plant parts as compared to climacteric or non-climacteric plants or plant parts not exposed to the composition. In some embodiments, exposure to the composition of the invention delays fruit ripening and pigmentation in climacteric or non-climacteric fruit as compared to climacteric or non-climacteric fruit not exposed to the composition. In some embodiments, exposure to the composition of the invention delays fruit ripening and pigmentation, while at the same time increasing fruit size as compared to fruit not exposed to the composition.

In an embodiment, the invention relates to a kit for promoting plant or plant part germination/sprouting, and/or delaying fruit ripening and pigmentation, the kit comprising at least one ABA antagonist as disclosed herein. In some embodiments of the invention, the kit for promoting plant or plant part germination/sprouting, and/or delaying fruit ripening and pigmentation optionally comprises a carrier, an adjuvant, an auxiliary, or an extender. In some embodiments of the invention, the kit for promoting plant or plant part germination/sprouting, and/or delaying fruit ripening and pigmentation comprises a surfactant and at least one ABA antagonist as disclosed herein.

In an embodiment, the invention relates to a method for promoting plant or plant part germination/sprouting, and/or delaying fruit ripening and pigmentation. The method comprises exposing a plant or plant part to a sufficient amount of a composition comprising at least one ABA antagonist as disclosed herein. In some embodiments of the invention, the plant or plant part exposed to a composition of the invention is a seed. In some embodiments of the invention, the plant or plant part exposed to a composition of the invention is a fleshy fruit.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 depicts images of the various stages of strawberry fruit development under normal conditions. Images were taken at different days after pollination (DAP): 0 DAP; 4 DAP; 6 DAP; 8 DAP; 10 DAP; 12 DAP; 14 DAP; 16 DAP; 18 DAP; and 20 DAP. The first picture on the left is of a pollinated flower; up to 14 DAP the strawberries appear green; at 16 DAP the strawberry appears white; at 17 DAP the strawberry appears with a pink tint; at 18 DAP only the top of the strawberry appears white; and at 20 DAP the strawberry appears red.

FIG. 2A to FIG. 2F depict images taken at different days after treatment (DAT) of strawberry fruit dipped in either 10 μM N-[3-chloro-4-(4-propionyl-1-piperazinyl)phenyl]-2-phenylacetamide (PAD) in 0.1% polyethylene glycol tert-octylphenyl ether (TRITON-X100 surfactant); 1 mM ABA in 0.1% TRITON-X100 surfactant; or buffer alone (0.1% TRITON-X100 surfactant); Mock. FIG. 2A shows images taken 7 DAT; all strawberries appear white or white with a greenish tint. FIG. 2B shows images taken 8 DAT; mock-treated and PAD-treated strawberries appear white with a greenish tint, and ABA-treated strawberries appear white. FIG. 2C shows images taken 9 DAT; mock-treated and ABA-treated strawberries appear with pink spots, while PAD-treated strawberries appear whit with a greenish tint. FIG. 2D shows images taken 10 DAT; mock treated strawberries appear with some red, ABA-treated strawberries appear mostly red, PAD-treated strawberries appear white with a greenish tint. FIG. 2E shows images taken 11 DAT; mock-treated and ABA-treated strawberries appear red, and PAD-treated strawberries appear white. FIG. 2F shows images taken 12 DAT, mock-treated and ABA-treated strawberries appear red, and PAD-treated strawberries appear red with some yellow.

FIG. 3A to FIG. 3H depict images of cherry tomatoes taken on the day of treatment or taken 6 DAT. FIG. 3A and FIG. 3B show images of cherry tomatoes injected with 10 UM PAD; the tomatoes in FIG. 3A appear green while the tomatoes in FIG. 3B appear with a yellow and/or yellow/red tint. FIG. 3C and FIG. 3D show images of cherry tomatoes injected with 200 μM ABA; the tomatoes in FIG. 3C appear green while the tomatoes in FIG. 3D appear red. FIG. 3E and FIG. 3F show images of cherry tomatoes injected with buffer alone; the tomatoes in FIG. 3E appear green, while the tomatoes in FIG. 3F appear red or yellowish/red. FIG. 3G and FIG. 3H show images of untreated cherry tomatoes; the tomatoes in FIG. 3G appear green while the tomatoes in FIG. 3H appear yellow or red with greenish tint. FIG. 3A; FIG. 3C; FIG. 3E; and FIG. 3G show images taken the day of treatment. FIG. 3B; FIG. 3D; FIG. 3E; and FIG. 3H show images taken 6 DAT.

FIG. 4A to FIG. 4F depict images taken at different days after treatment (DAT) of non-treated strawberry fruits (Control), or strawberry fruits injected 14 days after pollination with either 10 UM PAD in 0.1% TRITON-X100 surfactant; 200 μM ABA in 0.1% TRITON-X100 surfactant; or buffer alone (0.1% TRITON-X100 surfactant; Mock). FIG. 4A shows images taken 8 DAT; the control and mock-treated strawberries as well as one ABA-treated strawberry appear white with a greenish tint, the remaining ABA-treated strawberries and the PAD-treated strawberries appear with pink spots. FIG. 4B shows images taken 9 DAT; the control and mock-treated strawberries appear white with greenish or yellowish tint, the ABA-treated strawberries appear mostly red, and the PAD-treated strawberries appear orange. FIG. 4C shows images taken 10 DAT; the control strawberries appear white with a greenish tint, the mock-treated strawberries appear with some pink/yellow color, the ABA-treated and PAD-treated strawberries appear mostly red. FIG. 4D shows images taken 11 DAT; the control strawberries appear pinkish/yellowish, the mock treated strawberries appear pink or with some pink, the ABA-treated strawberries and the PAD-treated strawberries appear mostly red. FIG. 4E shows images taken 12 DAT; the control strawberries appear orange or pink, the mock-treated strawberries appear mostly pink, the ABA-treated and POAD-treated strawberries appear red. FIG. 4F shows images taken 13 DAT where all of the strawberries appear red.

### DETAILED DESCRIPTION

The present invention relates to compositions for promoting plant or plant part germination/sprouting, and/or delaying the fruit ripening and pigmentation process of plants or plant parts exposed to at least one composition of the invention as compared to plants or plant parts not exposed to the at least one composition.

Fresh fruits are highly perishable. Due to their short shelf-life about 40% of fresh fruits are wasted after harvest. Fruit quality and shelf life depend on fruit ripening, which is a complex physiological process, especially for non-climacteric fruits such as strawberry, grapes and citrus. The inventors have identified compounds useful in promoting germination/sprouting, and/or delaying the ripening/pigmentation process of climacteric and non-climacteric fruit. Prior to the instant invention there was no known efficient growth regulator to delay non-climacteric fruit ripening. At least some of the growth regulators of the invention also delay climacteric fruit ripening.

From a collection of about 10,000 small chemical compounds (around 300-400 Dalton), the inventors identified at least twelve compounds that promoted seed germination. Thus, the inventors have identified compositions comprising at least one ABA antagonist useful for promoting seed germination. The inventors also showed that at least one of the compounds is also useful for delaying fruit ripening and pigmentation. In some embodiments, the composition for promoting plant or plant part germination/sprouting and/or delaying fruit ripening and pigmentation may comprise at least one of N-[3-chloro-4-(4-propionyl-1-piperazinyl)phenyl]-2-phenylacetamide (PAD), N-(3-chloro-4-[4-(2,2-dimethylpropanoyl)-1-piperazinyl]phenyl)-2-phenylacetamide, 1-[(4-methoxyphenyl) sulfonyl]-3-piperidinecarboxamide, N-(3,4-dimethylphenyl)-N-(4-fluorobenzyl) methanesulfonamide, [3-(benzyloxy)benzyl]methylamine hydrochloride, 4-amino-2-(5,7-dimethyl-1,3-benzoxazol-2-yl)-6-methylphenol, N-cyclopropyl-N′-(2,3-dimethylphenyl) urea, N-[3-(1,3-benzoxazol-2-yl)-2-methylphenyl]-2-methylpropanamide, 3-[(2-fluorobenzyl)oxy]benzamide, N-[3-chloro-4-(4-propionyl-1-piperazinyl)phenyl]-2-methoxy-3-methylbenzamide, 6-chloro-N-(2,4-dimethylphenyl)-2-oxo-2H-chromene-3-carboxamide, methyl 2-{[(4-cyclohexyl-1-piperazinyl)carbonyl]amino}benzoate, or a derivative thereof. In an embodiment, the composition for promoting seed germination may delay fruit ripening and may retard fruit pigmentation. In some embodiments, the composition for delaying fruit ripening is an ABA antagonist having the following formula:

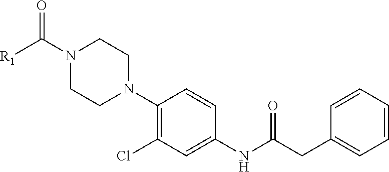

where R1 is dimethyl or propyl.

The inventors surprisingly found that seed contacted with the compositions of the invention germinate at a faster rate than seeds contacted with buffer alone. In the same manner, the inventors found it surprising that contacting climacteric or non-climacteric fruit with at least one composition of the invention, either on the vine or after harvest, fruit ripening was delayed as compared to mock-treated or non-treated fruit. In the instant application the inventors show that PAD has the ability to promote seed germination and delay strawberry and cherry tomato fruit ripening and pigmentation. Surprisingly, the inventors found that when strawberries were treated with PAD, not only was their ripening delayed, but the size of the strawberries increased. Application of 10 μM PAD to strawberries on day 9 after pollination, delayed strawberry fruit ripening by about 2 days when compared with mock-treated strawberries. Treatment of cherry tomatoes at mature green stage with 50 μM PAD resulted in about a seven-day delay in fruit ripening.

Ripening of fruits occurs when enzymes such as pectinase and amylase break down starches and pectin, which softens and sweetens the fruit. Another factor essential in fruit ripening is ethylene, a naturally occurring gas that triggers and promotes the ripening process. Climacteric fruits are those fruits that can ripen after harvest, and non-climacteric fruits are fruits that cannot ripen once removed from the plant. Climacteric fruit produce much more ethylene than non-climacteric fruit. Climacteric fruits include apple, avocado, banana, blueberry, breadfruit, cantaloupe, cherimoya, durian, feijoa, fig, guava, kiwifruit, mango, muskmelon, papaya, passion fruit, pear, persimmon, plantain, quince, sapodilla, sapote, soursop, apricot, nectarine, peach, plum, quince, and tomato. Some fruits, such as apples and bananas, produce more ethylene gas than other climacteric fruits. Non-climacteric fruit include blackberry, cherry, cucumber, eggplant, grape, grapefruit, lemon, lime, orange, pepper, pineapple, pomegranate, pumpkin, raspberry, squash, strawberry, watermelon, and zucchini.

In an embodiment, the invention relates to a method for promoting germination/sprouting and/or delaying fruit ripening and pigmentation. The method comprises exposing a plant or a plant part, to a sufficient amount of a composition comprising at least one ABA antagonist. In some embodiments of the invention, the plant or plant part exposed to the ABA antagonist is an apple, an avocado, a banana, a berry, a breadfruit, a cherimoya, a cherry, a citrus fruit, a cucumber, a date, a durian, an eggplant, a feijoa, a fig, a grape, a guava, a kiwifruit, a lychee, a mango, a melon, an okra, a papaya, a passion fruit, a pea, a pear, a pepper, a persimmon, a pineapple, a plantain, a pomegranate, a pumpkin, a quince, a sapodilla, a sapote, a squash, a tamarillo, a tomato, or a zucchini. In some embodiments of the invention, the citrus fruit contacted is a lemon, a lime, an orange, a grapefruit, a mandarin, or a tangerine. In some embodiments of the invention, the berry contacted is a strawberry, a mulberry, a blackberry, a blueberry, a raspberry, a boysenberry, a cranberry, a currant, an elderberry, a gooseberry, or a loganberry.

For non-climacteric fruit, increasing evidence indicates that the phytohormone abscisic acid (ABA) plays an important role in accelerating fruit ripening. The inventors have surprisingly shown ABA antagonists that promote seed germination and/or delay fruit development and ripening. By showing its effect on delaying fruit ripening, the inventors have shown that N-[3-chloro-4-(4-propionyl-1-piperazinyl)phenyl]-2-phenylacetamide (PAD) is an effective plant growth regulator. The inventors have also shown that N-(3-chloro-4-[4-(2,2-dimethylpropanoyl-1-piperazinyl]phenyl)-2-phenylacetamide, a chemical with 99% similarity to PAD, also has a delaying effect on fruit ripening.

In an embodiment, the invention relates to a composition comprising an ABA antagonist for promoting germination/sprouting and/or delaying fruit ripening and pigmentation. The compositions of the invention may comprise a surfactant such as polyethylene glycol tert-octylphenyl ether (TRITON-X100); polyoxyethylene (10) isooctylcyclohexyl ether (TRITON-X100 reduced); Polyoxyethylene (10) cetyl ether (BRIJ C10); polysorbate 20; octylphenoxypolyethoxyethanol; or nonylphenoxypolyethoxy ethanol.

In some embodiments of the invention, a composition of the invention may further comprise at least one additional chemical that is useful for reducing weeds or reducing pests. In some embodiments of the invention, the composition comprising at least one ABA antagonist further comprises at least one of a fungicide, an herbicide, a pesticide, a nematicide, an insecticide, a plant activator, a synergist, an herbicide safener, a plant growth regulator, an insect repellant, an acaricide, a molluscicide, or a fertilizer. In some embodiments of the invention, the composition comprising an ABA antagonist may further comprise a surfactant. In some embodiments of the invention, the composition comprising an ABA antagonist further comprises a carrier.

In an embodiment, the invention relates to a kit for promoting plant or plant part germination/sprouting and/or for delaying fruit ripening and pigmentation. The kit comprises at least one ABA antagonist as disclosed herein. In some embodiments of the invention, the kit comprises at least one of N-[3-chloro-4-(4-propionyl-1-piperazinyl)phenyl]-2-phenylacetamid (PAD), N-(3-chloro-4-[4-(2,2-dimethylpropanoyl)-1-piperazinyl]phenyl)-2-phenylacetamide, 1-[(4-methoxyphenyl) sulfonyl]-3-piperidinecarboxamide, N-(3,4-dimethylphenyl)-N-(4-fluorobenzyl) methanesulfonamide, [3-(benzyloxy)benzyl]methylamine hydrochloride, 4-amino-2-(5,7-dimethyl-1,3-benzoxazol-2-yl)-6-methylphenol, N-cyclopropyl-N′-(2,3-dimethylphenyl) urea, N-[3-(1,3-benzoxazol-2-yl)-2-methylphenyl]-2-methylpropanamide, 3-[(2-fluorobenzyl)oxy]benzamide, N-[3-chloro-4-(4-propionyl-1-piperazinyl)phenyl]-2-methoxy-3-methylbenzamide, 6-chloro-N-(2,4-dimethyl phenyl)-2-oxo-2H-chromene-3-carboxamide, methyl 2-{[(4-cyclohexyl-1-piperazinyl)carbonyl]amino}benzoate; or a derivative thereof.

The kit may optionally comprise a carrier, an adjuvant, an auxiliary, or an extender. The kit may comprise a surfactant such as polyethylene glycol tert-octylphenyl ether (TRITON-X100); polyoxyethylene (10) isooctylcyclohexyl ether (TRITON-X100 reduced); Polyoxyethylene (10) cetyl ether (BRIJ C10); polysorbate 20; octylphenoxypolyethoxyethanol; or nonylphenoxypolyethoxy ethanol. The kit may comprise one or more containers. In some embodiments, the composition comprising an ABA antagonist may in the same container as at least one carrier, adjuvant, auxiliary, or extender. In some embodiments, the composition comprising an ABA antagonist may be in one container and the at least one carrier, adjuvant, auxiliary, or extender may be in at least one different container. In some embodiments of the invention, kit may comprise one or more containers with one or more compartments. In some embodiments of the invention, the composition comprising at least one ABA antagonist may be in a first compartment, and the at least one carrier, adjuvant, auxiliary, or extender may be in at least one second compartment of the same container.

In an embodiment, the invention provides a method for promoting plant or plant part germination/sprouting, and/or delaying fruit ripening and pigmentation. The method comprising the step of contacting a plant or plant part with a sufficient amount of a composition comprising an ABA antagonist to promote germination/sprouting and/or delay fruit ripening and pigmentation compared to the germination/sprouting and/or fruit ripening and pigmentation of a plant or plant part not contacted with the composition. In some embodiments of the invention, the plant or plant part treated with a composition comprising an ABA antagonist is a monocotyledon. In some embodiments of the invention, the plant or plant part treated with a composition comprising an ABA antagonist is a dicotyledon.

The composition comprising at least one ABA antagonist can be applied to plants or plant parts using at least one of a variety of methods known in the art. The composition comprising at least one ABA antagonist may be applied to the target plant or plant part using a variety of conventional methods such as dusting, coating, injecting, rubbing, rolling, dipping, spraying, or brushing, or any other appropriate technique which does not significantly injure the target plant or plant part to be treated. Methods of applying the composition comprising at least one ABA antagonist to plants or plant parts may be, e.g., by spraying, atomizing, dipping, pouring, irrigating, dusting, or scattering the compositions over the propagation material, or by brushing or pouring the composition over the plant or plant part. When the plant part is a seed, application may be done, for example, by injecting, coating, encapsulating, atomizing, spraying, dipping, or immersing the seed in a liquid composition comprising an ABA antagonist, or otherwise treating the seed. When the plant part is a fruit, application of a composition comprising an ABA antagonist may be done by dusting, coating, injecting, rubbing, rolling, dipping, spraying, or brushing, or any other appropriate technique which does not significantly injure the fruit. In an alternative, the compositions comprising an ABA antagonist can be introduced into the soil by spraying, scattering, pouring, irrigating, or otherwise treating the soil.

Compositions comprising an ABA antagonist may be in any customary form suitable for application, such as solutions, emulsions, wettable powders, water-based suspensions, oil-based suspensions, powders, dusts, pastes, soluble powders, soluble granules, granules for broadcasting, suspension-emulsion concentrates, natural materials impregnated with active compound, synthetic materials impregnated with active compound, fertilizers, or microencapsulation in polymeric substances. Compositions comprising an ABA antagonist may be produced in a known manner, for example by mixing the ABA antagonist with suitable adjuvants, extenders, and/or surfactants. Extenders may be liquid solvents and/or solid carriers. Surfactants may be emulsifiers and/or dispersants and/or foam-formers. The compositions may be prepared ahead of time, immediately before application, or during application.

The ABA antagonists for use in the present invention may be used in conjunction with an adjuvant, which aids absorption of the compound into the desired seed, plant, plant part, and/or fruit. Suitable adjuvants include inorganic or organic chemicals and macromolecules, or any mixtures thereof. In some embodiments of the present invention, the adjuvant may predominantly consist of methyl or ethyl esters (or mixtures thereof) of fatty acids originating from plant oils, optionally the plant oils may be selected from sunflower oil, canola oil, rapeseed oil, soybean oil, corn oil, or the like. By way of example, suitable adjuvants for use in the present invention include HASTEN, KWICKEN, UPTAKE, ROCKET, AUREO, STEFES MERO, DYNE-AMIC, BIOPEST, AGRIDEX, or ZAP. In another embodiment of the present invention, the adjuvant may be from the class of polyalkoxylated triglycerides that may be described by CAS 70377-91-2 or CAS 165658-61-7 and that are commercially available. In an embodiment, the adjuvant may be selected from a class of C8-C10 polyethoxylated fatty alcohols. By way of example, suitable adjuvants may be selected from the class of polyethoxylated alcohols that may be described by CAS 9043-30-5 or 27213-90-7, and that are commercially available. In an embodiment, the adjuvant may be selected from a class of C8-C10 polyalkoxylated fatty alcohols. By way of example, suitable adjuvants may be selected from the class of polypropoxylated-ethoxylated alcohols that may be described by CAS 64366-70-7 and that may be commercially available.

Unless otherwise explained, all technical and scientific terms used herein have the same meaning as commonly understood by one of ordinary skill in the art to which this disclosure belongs. The singular terms “a”, “an”, and “the” include plural referents unless context clearly indicates otherwise. Similarly, the word “or” is intended to include “and” unless the context clearly indicate otherwise.

As used herein, the term “mock-treated” means that the seed, plant, plant part, or fruit has been treated with buffer in the absence of at least one ABA antagonist.

As used herein, the term “control” refers to a seed, plant, plant part, or fruit that is not treated with a composition of the invention or with a buffer, but its germination/sprouting and/or fruit ripening is analyzed at the same time as a seed, plant, plant part, or fruit that is treated with a composition of the invention or with a buffer.

As used herein, the term “ABA antagonist” refers to a molecule that has an opposite effect as ABA.

As used herein, the term “a derivative thereof” refers to a chemical substance related structurally to at least one of the ABA antagonists described herein, and that is theoretically derivable from it.

As used herein, the term “exposing” means generally bringing into contact with. Exposure may be direct or indirect. Exposure of seed, fruit, plant, or plant part to a compound of the invention includes administration of the compound to the seed, fruit, plant, or part thereof, otherwise bringing the seed, fruit, plant, or part thereof (e.g. leaves or roots) into contact with the compound itself. Contacting with the compound may be done by spraying, immersing, injecting the seed, fruit, plant, or part thereof; or by contacting with the compound a surface or solution in which the seed, plant, fruit, or part thereof is present. In the present disclosure, the terms “exposing,” “administering,” “contacting,” and variations thereof may, in some contexts, be used interchangeably.

As used herein, the term “sufficient amount” denotes an amount of a composition comprising at least one ABA antagonist sufficient to promote seed germination, and/or to delay fruit ripening and pigmentation, and which does not result in damage to the plant or plant part. Such amount can vary in a broad range and is dependent on various factors such as the plant or plant part exposed, the climatic and/or soil conditions, and the specific ABA antagonist in the composition.

As used herein, the term “fleshy fruit” refers to fruit consisting largely of soft succulent tissue.

As used herein, the term “about” is defined as plus or minus ten percent of a recited value. For example, about 1.0 g means 0.9 g to 1.1 g.

As used herein, it is intended that reference to a range of numbers (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

As used herein, the term “carrier” includes a natural or synthetic, organic or inorganic solid or liquid substance with which an active compound is mixed or bonded, for example to provide better applicability, in particular for application to plants or parts of plants. The carrier, which may be solid or liquid, is generally inert and should be suitable for use in agriculture.

As used herein, the term “adjuvant” includes an agent that modifies the effect of the active compound for use in the present invention. An adjuvant may be an auxiliary. Suitable auxiliaries for use in the present invention include substances that are suitable for imparting to the composition itself and/or to preparations derived therefrom (for example spray liquors, seed dressings) particular properties such as certain technical properties and/or also particular biological properties. Typical suitable auxiliaries are: extenders, solvents and carriers.

Suitable solid carriers for use in the present invention include, for example, ammonium salts, ground natural minerals, and ground synthetic minerals. These may be selected from at least kaolins, clays, talc, chalk, quartz, attapulgite, montmorillonite, or diatomaceous earth. Suitable solid carriers for granules include, for example, crushed and fractionated natural rocks, synthetic granules of inorganic and organic meals, granules of organic material. Suitable emulsifiers and/or foam-formers include, for example, non-ionic and anionic emulsifiers, such as polyoxyethylene fatty acid esters, polyoxyethylene fatty alcohol ethers, for example alkylaryl polyglycol ethers, alkylsulphonates, alkyl sulphates, arylsulphonates and also protein hydrolysates; suitable dispersants are nonionic and/or ionic substances, for example from the classes of the alcohol/POE and/or POP ethers, acid and/or POP/POE esters, alkylaryl and/or POP/POE ethers, fat and/or POP/POE adducts, POE and/or POP polyol derivatives, POE and/or POP/sorbitan or sugar adducts, alkyl or aryl sulphates, sulphonates and phosphates, or the corresponding PO ether adducts. Suitable oligomers or polymers, for example those derived from vinylic monomers, from acrylic acid, from EO and/or PO alone or in combination with, for example, (poly) alcohols or (poly)amines. It is also possible to employ lignin and its sulphonic acid derivatives, unmodified and modified celluloses, aromatic and/or aliphatic sulphonic acids and their adducts with formaldehyde.

Embodiments of the present invention are shown and described herein. It will be obvious to those skilled in the art that such embodiments are provided by way of example only. Numerous variations, changes, and substitutions will occur to those skilled in the art without departing from the invention. Various alternatives to the embodiments of the invention described herein may be employed in practicing the invention. It is intended that the included claims define the scope of the invention and that methods and structures within the scope of these claims and their equivalents are covered thereby. All publications, patents, and patent applications mentioned in this specification are herein incorporated by reference to the same extent as if each individual publication, patent, or patent application was specifically and individually indicated to be incorporated by reference.

### EXAMPLES

Having now generally described this invention, the same will be better understood by reference to certain specific examples, which are included herein only to further illustrate the invention and are not intended to limit the scope of the invention as defined by the claims.

### Example 1

### Chemical Library Screening

Chemical libraries of small compounds were screened for compounds capable of promoting seed germination, delaying the fruit ripening process, and/or retarding fruit pigmentation.

A chemical library containing 10,000 small compounds (˜300 Dalton) was purchased from ChemBridge Co (San Diego, California, USA). Strawberry seeds (Fragaria x ananassa CV. Albion) were purchased from Johnny's Seeds (Fairfield, Maine, USA). Five to six seeds were sterilized with 70% ethanol and added to each well of 96 well ELISA plates containing about 5 μM chemical in 0.1% TRITON X-100 surfactant (polyethylene glycol tert-octylphenyl ether). One mM abscisic acid (ABA), a hormone that inhibits seed germination, and gibberellic acid (GA3), a hormone that promotes seed germination, were used as controls. Each experiment was conducted in triplicate. Plates were kept in a growth chamber at 25 C under dark, and a 14 hour light/10 hour dark cycle was added after seed germination was observed. Twelve chemicals showed significant effect in promoting seed germination.

The twelve chemicals identified as promoting seed germination are listed below:

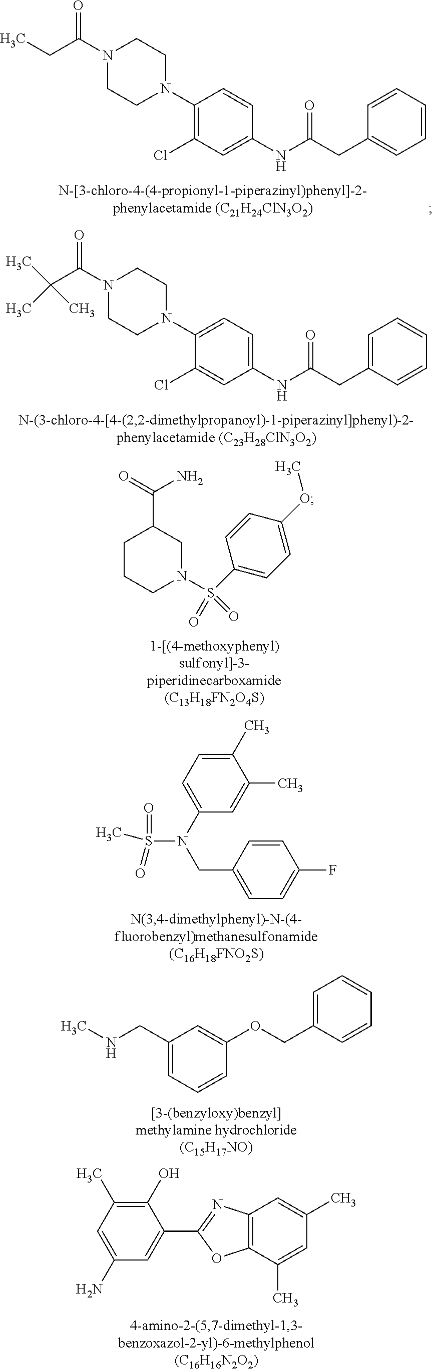 [SMILES: CCC(=O)N1CCN(c2ccc(NC(=O)Cc3ccccc3)cc2Cl)CC1 ; CC(C)(C)C(=O)N1CCN(c2ccc(NC(=O)Cc3ccccc3)cc2Cl)CC1 ; COc1ccc(S(=O)(=O)N2CCCC(C(N)=O)C2)cc1 ; Cc1ccc(N(Cc2ccc(F)cc2)S(C)(=O)=O)cc1C ; CNCc1cccc(OCc2ccccc2)c1 ; Cc1cc(C)c2oc(-c3cc(N)cc(C)c3O)nc2c1]

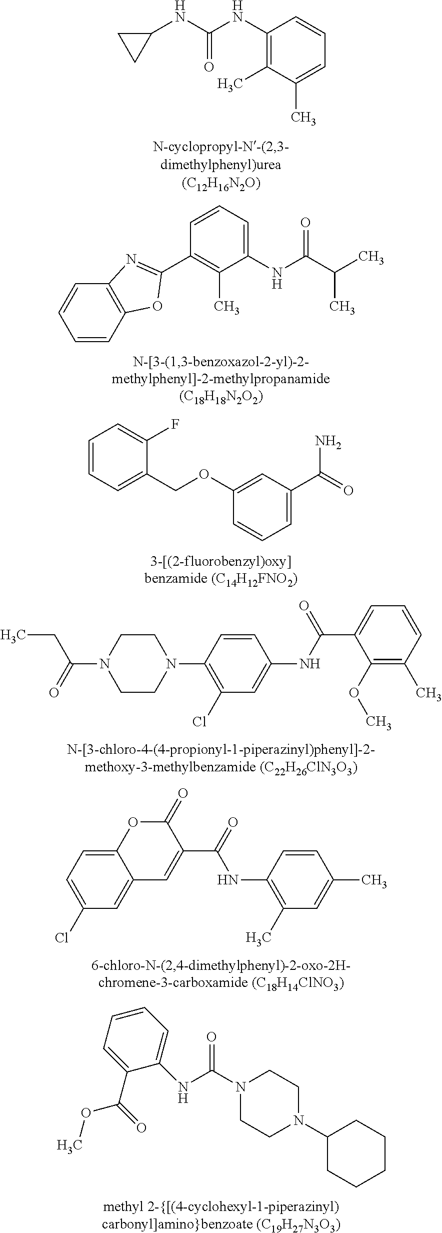

The effects on fruit development and ripening of these twelve chemicals were tested. Each of these chemicals delayed fruit development to a different extent.

In this example twelve chemicals were identified with the ability to promote seed germination.

### Example 2

### Treatment of Strawberry Fruit

One of the twelve chemicals identified in Example 1 as promoting seed germination was tested for its effect on strawberry fruit ripening.

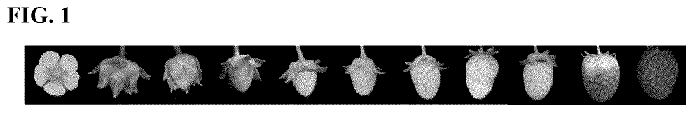

Strawberry plants (Fragaria x ananassa CV. Albion) were grown in a greenhouse at 28° C. and 14-hour light/10-hour dark conditions. Eight days after pollination, fruits were dipped for 20 seconds in 10 UM PAD in 0.1% TRITON X-100 surfactant; 1 mM ABA in 0.1% TRITON X-100 surfactant; or buffer alone (0.1% Triton X-100). Fruits were allowed to continue growing on the plants. FIG. 1 depicts images of strawberry fruit development under standard conditions. This figure shows that in the normal developing process, the red color first starts to appear on the strawberry at day 16 or 17 after pollination.

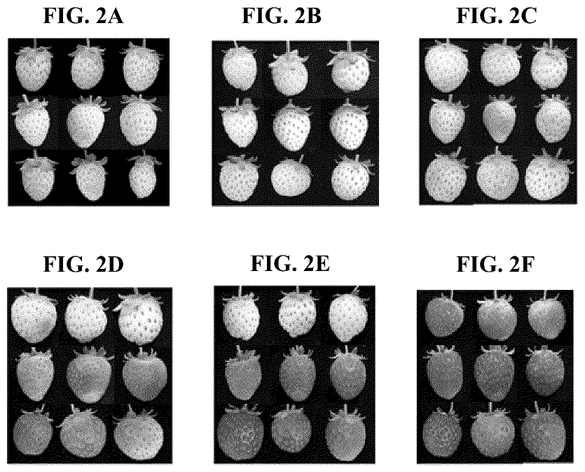

Of the twelve chemicals identified in Example 1 as promoting seed germination, N-[3-chloro-4-(4-propionyl-1-piperazinyl)phenyl]-2-phenylacetamide was named “PAD,” and used for further study. FIG. 2A to FIG. 2F depict images of strawberries dipped in either 10 UM PAD in 0.1% TRITON X-100 surfactant; 1 mM ABA in 0.1% TRITON X-100 surfactant; or buffer alone (10% TRITON-X 100 surfactant; mock-treated) FIG. 2A shows images of strawberries 7 days after treatment (DAT); FIG. 2B shows images of strawberries at 8 DAT; FIG. 2C shows images of strawberries at 9 DAT; FIG. 2D shows images of strawberries at 10 DAT; FIG. 2E shows images of strawberries at 11 DAT; and FIG. 2F shows images of strawberries at 12 DAT. As seen in FIG. 2A to FIG. 2F, PAD delayed fruit ripening when compared to mock-treated fruit, and ABA stimulated strawberry fruit ripening when compared to mock-treated strawberries. Mock-treated fruit started to turn red at 10 DAT, and reached full red at 12 DAT. ABA-treated fruit started to turn red 9 DAT, and reached full red 11 DAT. In contrast, PAD-treated fruit only started turning red 12 DAT.

The fresh weight of strawberry fruit treated with PAD was about 10% larger than that of mock-treated strawberries. There was no difference in the sugar content between PAD-treated strawberry fruit and that of mock-treated controls.

This example shows that at least one of the compounds that promoted seed germination, PAD, also delayed strawberry fruit ripening when compared to strawberries treated with buffer alone.

### Example 3

### Treatment of Cherry Tomatoes

The possibility of PAD having an effect on ripening of climacteric fruits was tested.

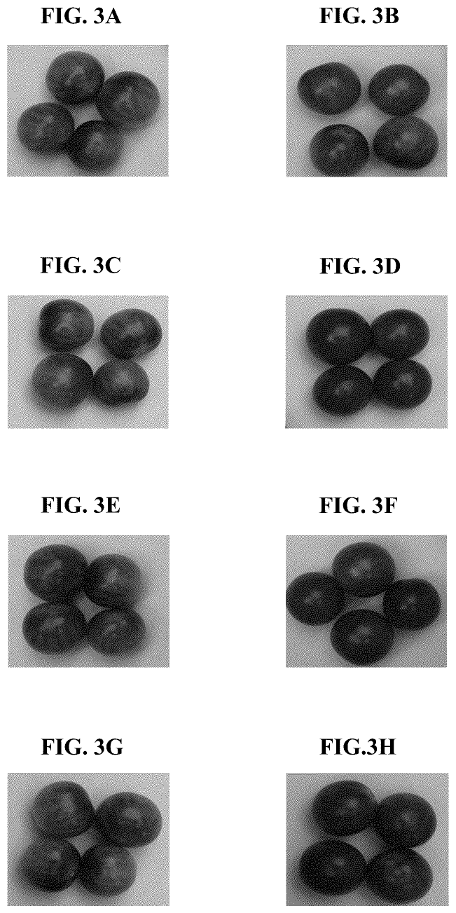

Cherry tomato fruits at mature green stage were purchased from Butler's Orchard (Germantown, Maryland, USA). Each fruit was injected with either 50 μM PAD in 0.1% TRITON X-100 surfactant; 200 μM ABA in 0.1% TRITION X-100 surfactant; or buffer alone (0.1% TRITON X-100 surfactant). Six days after treatment ABA-treated fruits were fully ripen (red stage), untreated fruits and fruits treated with buffer alone (mock) were at a pink stage, and PAD-treated fruits were still at a green stage. FIG. 3A and FIG. 3B show images of cherry tomatoes injected with 50 UM PAD. FIG. 3C and FIG. 3D show images of cherry tomatoes injected with 200 μM ABA. FIG. 3E and FIG. 3F show images of cherry tomatoes injected with buffer alone. FIG. 3G and FIG. 3H show images of untreated tomatoes. FIG. 3A; FIG. 3C; FIG. 3E; and FIG. 3G show images taken the day of treatment. FIG. 3B; FIG. 3D; FIG. 3E; and FIG. 3H show images taken 6 DAT. These Figures clearly show that PAD treatment resulted in a delay in cherry tomato ripening when compared to mock-treated cherry tomatoes, or untreated cherry tomatoes.

These results demonstrated that, same as with non-climacteric strawberries, PAD delayed fruit ripening of climacteric tomatoes.

### Example 4

### Pad Analogs

Chemicals with similarity to PAD were tested for their ability to delay fruit ripening.

To the inventors' knowledge, no chemical closely-related to PAD is currently commercially available. A few analogs with 88-99% similarity to PAD were found in the ChemBridge database used in Example 1.

N-(3-chloro-4-[4-(2,2-dimethylpropanoyl)-1-piperazinyl]phenyl)-2-phenylacetamide has 99% similarity to PAD, and delayed strawberry fruit ripening when 50 μM of the compound in 0.1% TRITON-X 100 surfactant were applied at the same timing as PAD, although much less effectively than PAD.

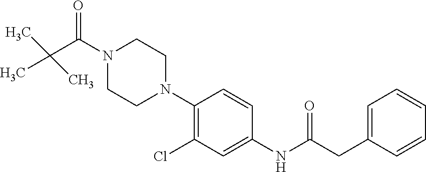 [SMILES: CC(C)(C)C(=O)N1CCN(c2ccc(NC(=O)Cc3ccccc3)cc2Cl)CC1]

2-(4-chlorophenyl)-N-[4-(4-isobutyryl-1-piperazinyl)phenyl]acetamide has 93% similarity to PAD. When applying 50 μM of this chemical in 0.1% TRITON-X 100 surfactant no obvious effect on strawberry fruit ripening was seen.

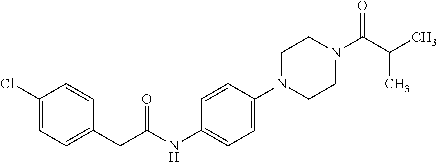 [SMILES: CC(C)C(=O)N1CCN(c2ccc(NC(=O)Cc3ccc(Cl)cc3)cc2)CC1]

N-(3-chloro-4-(4-isobutyryl-1-piperazinyl)phenyl]-2,2-diphenylacetamide also has 93% similarity to PAD. When applying 50 μM of this chemical in 0.1% TRITON-X 100 surfactant no obvious effect on strawberry fruit ripening was seen.

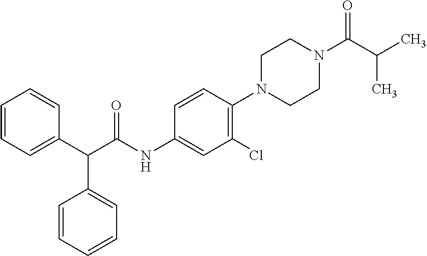 [SMILES: CC(C)C(=O)N1CCN(c2ccc(NC(=O)C(c3ccccc3)c3ccccc3)cc2Cl)CC1]

The results shown in this example indicate that a chemical with 99% similarity to PAD delays fruit ripening, albeit not as effectively as PAD. The results also indicate that other chemicals with similarity to PAD had no obvious effect on fruit ripening.

### Example 5

### Injection of Strawberries

The ability of PAD to delay fruit ripening when injected into strawberries was also tested.

Strawberry plants (Fragaria x ananassa CV. Albion) were grown and maintained as disclosed above. Fourteen days after pollination fruits were injected with 10 UM PAD in 0.1% TRITON X-100 surfactant; 200 μM ABA in 0.1% TRITON X-100 surfactant; or buffer alone (0.1% Triton X-100 surfactant).

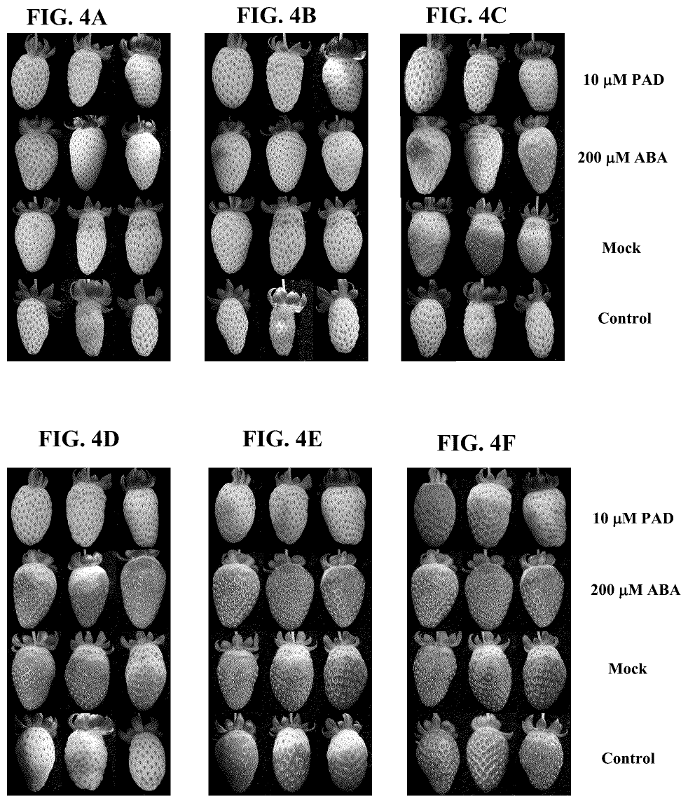

FIG. 4A to FIG. 4F depict images of strawberries treated with either 10 UM PAD in 0.1% TRITON X-100 surfactant; 200 μM ABA in 0.1% TRITON X-100 surfactant; buffer alone (10% TRITON-X 100 surfactant; mock-treated); or not injected (control). FIG. 4A shows images of strawberries 8 days after treatment (DAT); FIG. 4B shows images of strawberries at 9 DAT; FIG. 4C shows images of strawberries at 10 DAT; FIG. 4D shows images of strawberries at 11 DAT; FIG. 4E shows images of strawberries at 12 DAT; and FIG. 4F shows images of strawberries at 13 DAT. As seen in FIG. 4A to FIG. 4F, PAD delayed fruit ripening when compared to not-treated fruit, mock-treated fruit, and ABA treated. Control fruit started to turn red 11 DAT, and reached full red at 12 DAT. Mock-treated fruit started to turn red at 10 DAT, and reached full red at 12 DAT. ABA-treated fruit started to turn red 9 DAT, and reached full red 11 DAT. In contrast, PAD-treated fruit only started turning red 12 DAT.

This example shows that the effect of PAD on fruit ripening is independent of the application method (dipping, as in Example 2, or injection, as above).

We claim:

1.-20. (canceled)

21. A composition for promoting-germination/sprouting of a plant or plant part and/or delaying fruit ripening and pigmentation, the composition comprising an agriculturally-acceptable carrier, adjuvant, auxiliary, or extender, and at least one of N-[3-chloro-4-(4-propionyl-1-piperazinyl)phenyl]-2-phenylacetamide; N-(3-chloro-4-[4-(2,2-dimethylpropanoyl)-1-piperazinyl]phenyl)-2-phenylacetamide; 1-[(4-methoxyphenyl) sulfonyl]-3-piperidinecarboxamide; N-(3,4-dimethylphenyl)-N-(4-fluorobenzyl) methanesulfonamide; [3-(benzyloxy)benzyl]methylamine hydrochloride; 4-amino-2-(5,7-dimethyl-1,3-benzoxazol-2-yl)-6-methylphenol; N-cyclopropyl-N′-(2,3-dimethylphenyl) urea; N-[3-(1,3-benzoxazol-2-yl)-2-methylphenyl]-2-methylpropanamide; 3-[(2-fluorobenzyl)oxy]benzamide; N-[3-chloro-4-(4-propionyl-1-piperazinyl)phenyl]-2-methoxy-3-methylbenzamide; 6-chloro-N-(2,4-dimethylphenyl)-2-oxo-2H-chromene-3-carboxamide; methyl 2-{[(4-cyclohexyl-1-piperazinyl)carbonyl]amino}benzoate.

22. The composition of claim 21, wherein the composition comprises a surfactant.

23. The composition of claim 22, wherein the surfactant is polyethylene glycol tert-octylphenyl ether; polyoxyethylene (10) isooctylcyclohexyl ether; polyoxyethylene (10) cetyl ether; polysorbate 20; octylphenoxypolyethoxy ethanol; or nonylphenoxypolyethoxy ethanol.

24. The composition of claim 21, wherein exposure of fruit to the composition also increases fruit size when compared to fruit not exposed to the composition.

25. A kit for promoting plant or plant part germination/sprouting and/or delaying fruit ripening and pigmentation, the kit comprising a composition comprising an agriculturally-acceptable carrier, adjuvant, auxiliary, or extender, and at least one of N-[3-chloro-4-(4-propionyl-1-piperazinyl)phenyl]-2-phenylacetamide; N-(3-chloro-4-[4-(2,2-dimethylpropanoyl)-1-piperazinyl]phenyl)-2-phenylacetamide; 1-[(4-methoxyphenyl) sulfonyl]-3-piperidinecarboxamide; N-(3,4-dimethylphenyl)-N-(4-fluorobenzyl) methanesulfonamide; [3-(benzyloxy)benzyl]methylamine hydrochloride; 4-amino-2-(5,7-dimethyl-1,3-benzoxazol-2-yl)-6-methylphenol; N-cyclopropyl-N′-(2,3-dimethylphenyl) urea; N-[3-(1,3-benzoxazol-2-yl)-2-methylphenyl]-2-methylpropanamide; 3-[(2-fluorobenzyl)oxy]benzamide; N-[3-chloro-4-(4-propionyl-1-piperazinyl)phenyl]-2-methoxy-3-methylbenzamide; 6-chloro-N-(2,4-dimethylphenyl)-2-oxo-2H-chromene-3-carboxamide; methyl 2-{[(4-cyclohexyl-1-piperazinyl)carbonyl]amino}benzoate.

26. The kit of claim 25, wherein the kit comprises a surfactant.

27. The kit of claim 26, wherein the surfactant is polyethylene glycol tert-octylphenyl ether; polyoxyethylene (10) isooctylcyclohexyl ether; polyoxyethylene (10) cetyl ether; polysorbate 20; octylphenoxypolyethoxyethanol; or nonylphenoxypolyethoxyethanol.

28. The kit of claim 25, wherein the at least one ABA antagonist is N-[3-chloro-4-(4-propionyl-1-piperazinyl)phenyl]-2-phenylacetamide.

29. A method for promoting germination/sprouting of a plant or plant part and/or delaying fruit ripening and/or pigmentation, the method comprising exposing a plant or a plant part to a sufficient amount of a composition comprising an agriculturally-acceptable carrier, adjuvant, auxiliary, or extender and at least one ABA antagonist, wherein the at least one ABA agonist is N-[3-chloro-4-(4-propionyl-1-piperazinyl)phenyl]-2-phenylacetamide; N-(3-chloro-4-[4-(2,2-dimethylpropanoyl)-1-piperazinyl]phenyl)-2-phenylacetamide; 1-[(4-methoxyphenyl) sulfonyl]-3-piperidinecarboxamide; N-(3,4-dimethylphenyl)-N-(4-fluorobenzyl) methanesulfonamide; [3-(benzyloxy)benzyl]methylamine hydrochloride; 4-amino-2-(5,7-dimethyl-1,3-benzoxazol-2-yl)-6-methylphenol; N-cyclopropyl-N′-(2,3-dimethylphenyl) urea; N-[3-(1,3-benzoxazol-2-yl)-2-methylphenyl]-2-methylpropanamide; 3-[(2-fluorobenzyl)oxy]benzamide; N-[3-chloro-4-(4-propionyl-1-piperazinyl)phenyl]-2-methoxy-3-methylbenzamide; 6-chloro-N-(2,4-dimethylphenyl)-2-oxo-2H-chromene-3-carboxamide; methyl 2-{[(4-cyclohexyl-1-piperazinyl)carbonyl]amino}benzoate.

30. The method of claim 29, wherein the composition further comprises a carrier, an adjuvant, an auxiliary, or an extender.

31. The method of claim 29, wherein the composition comprises a surfactant.

32. The method of claim 31, wherein the surfactant is polyethylene glycol tert-octylphenyl ether; polyoxyethylene (10) isooctylcyclohexyl ether; polyoxymethylene (10) cetyl ether; polysorbate 20; octylphenoxypolyethoxyethanol; or nonylphenoxypolyethoxyethanol.

33. The method of claim 29, wherein the plant or plant part exposed to a composition comprising at least one ABA antagonist is a seed.

34. The method of claim 29, wherein the plant or plant part exposed to a composition comprising at least one ABA antagonist is a fleshy fruit.
